(19) United States
(12) Patent Application Publication
(10) Pub. No.: US 2026/0367583 A1
(43) Pub. Date: Nov. 19, 2026

(54) SECURE MOBILE ACCESS FOR ON-LOAD TAP-CHANGER DEVICE

(71) Applicant: Maschinenfabrik Reinhausen GmbH, Regensburg (DE)

(72) Inventors: Christian LEMBKE, Regensburg (DE); Andreas KURZ, Frankfurt (DE)

(21) Appl. No.: 19/121,857

(22) PCT Filed: Sep. 21, 2023
(86) PCT No.: PCT/EP2023/075996

§ 371 Date: Apr. 17, 2025

(30) Foreign Application Priority Data
Oct. 28, 2022 (DE) 10 2022 128 789.0

(51) Int. Cl. G05B 9/02; H02J 3/001

(52) U.S. Cl. CPC G05B 9/02; H02J 3/001

(57) ABSTRACT

An on-load tap-changer device, including a controller and an on-load tap-changer. The controller is designed and configured to produce a first data connection to a first operating unit. The controller is designed and configured to produce a second data connection to a second operating unit. The controller is designed and configured to use respective data connection of the first and second data connections to the first and second operating units to grant access to the controller and the on-load tap-changer. The controller is designed and configured to prevent the second data connection between the second operating unit and the controller while the first data connection exists between the first operating unit and the controller.

### CROSS REFERENCE TO RELATED APPLICATIONS

This application is a U.S. National Phase application under 35 U.S.C. § 371 of International Application No. PCT/EP2023/075996, filed on Sep. 21, 2023, and claims benefit to German Patent Application No. DE 10 2022 128 789.0, filed on Oct. 28, 2022. The International Application was published in German on May 2, 2024 as WO 2024/088660 A1 under PCT Article 21(2).

### FIELD

The invention relates to an on-load tap-changer device and secure mobile access to an on-load tap-changer device.

### BACKGROUND

To maintain on-load tap-changers, it is necessary to take all measures to protect service engineers on site during maintenance. Therefore, it is not uncommon for the entire tapped transformer to be taken off the grid for maintenance. This is complex and costly, however.

### SUMMARY

In an embodiment, the present disclosure provides an on-load tap-changer device, comprising a controller and an on-load tap-changer. The controller is designed and configured to produce a first data connection to a first operating unit. The controller is designed and configured to produce a second data connection to a second operating unit. The controller is designed and configured to use respective data connection of the first and second data connections to the first and second operating units to grant access to the controller and the on-load tap-changer. The controller is designed and configured to prevent the second data connection between the second operating unit and the controller while the first data connection exists between the first operating unit and the controller.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an embodiment of an on-load tap-changer device; and

FIG. 2 shows a method sequence for mobile access to the on-load tap-changer.

### DETAILED DESCRIPTION

In an embodiment, the present disclosure provides an on-load tap-changer device and a method for mobile access to an on-load tap-changer device that permit safe and cost-effective maintenance.

The foregoing is achieved by an on-load tap-changer device and a method for mobile access to an on-load tap-changer device according to the present disclosure.

According to a first aspect, the present disclosure provides an on-load tap-changer device, comprising:
a control device and an on-load tap-changer;
wherein the control device is designed and configured to produce a first data connection to a first operating unit;
wherein the control device is designed and configured to produce a second data connection to a second operating unit;
wherein the control device is designed and configured to use the respective data connection to the operating units to grant access to the control device and thus the on-load tap-changer;
wherein the control device is designed and configured to prevent the second data connection between the second operating unit and the control device while the first data connection exists between the first operating unit and the control device.

The on-load tap-changer device permits all data connections to a second operating unit to be prevented as soon as a service engineer on site is connected to the on-load tap-changer device by means of a first operating unit using short-range communication. Switching signals or other instructions from a second operating unit, e.g. from a remote control station, are prevented in this way so that only a service engineer on site can operate the on-load tap-changer device or has access to it. Fault scenarios on site are avoided. A high level of safety for service engineers is ensured during maintenance.

The on-load tap-changer can be designed in any manner and comprise a diverter switch and selector, for example. The load diverter can comprise vacuum switching tubes or semiconductor switching elements, for example. The on-load tap-changer is preferably actuated by means of a motor drive controlled by the control device. The motor drive is mechanically connected directly or indirectly to the on-load tap-changer.

The control device of the on-load tap-changer device can be designed in any manner and comprise a first communication module, for example, which is a short-range communication module. The first communication module monitors the close range of the on-load tap-changer device in a radius of up to 20 meters. The first communication module is preferably a Bluetooth or WLAN module.

The control device of the on-load tap-changer device can be designed in any manner and comprise a second communication module, for example, which is a long-range communication module. The second communication module is preferably connected to a second operating unit or has a second data connection thereto. The second communication module is preferably an LTE, 5G, MESH, LoRaWAN, Low Power Wide Area Network (LPWAN) e.g. Mioty or any mobile radio module.

The first operating unit can be designed in any manner, for example as an external operating unit, in particular as a smartphone, PDA or notebook. The first operating unit comprises a corresponding communication module, which corresponds with the first communication module of the control device and permits a data connection.

The second operating unit can be designed in any manner, for example as an external operating unit, in particular as a server. The second operating unit comprises a corresponding communication module, which corresponds with the second communication module of the control device and permits a data connection. After the first data connection has been produced, the first operating unit is granted access to the control device and thus to the on-load tap-changer device.

The control device is used for directly or indirectly actuating the on-load tap-changer. Directly means that the control device is designed and configured to independently control or actuate the on-load tap-changer via the motor drive. Indirectly means that the control device is used as a link between the operating units and permits the operating units to actuate the on-load tap-changer; by granting access.

The operating units can be of any design, for example as output units and input units. Output unit means that the data and signals received from the control device are output in the form of data and graphs. Input units means that, for example, switching commands can be input into the operating unit, which are then executed by the control device following transmission via the data connection.

Any data connection between the operating units and the control device allows data, signals and/or control/switching commands to be transmitted; in other words, access to the control device is granted. The data connections are bidirectional data connections.

The control device of the on-load tap-changer device is configured and designed to prevent the data connection to the second operating unit when there is a first data connection to the first operating unit. Access by the second operating unit is denied and the first operating unit is granted access. Preventing or denying within the context of the present disclosure means that control commands, switching commands and/or signals that are transmitted to or reach the control device via the second data connection are ignored and/or not processed further and/or cancelled.

According to a second aspect, the present disclosure provides a method for mobile access to an on-load tap-changer device, comprising the following steps:
monitoring a close range by means of a control device and detecting a first operating unit;
producing a first connection between the first operating unit and the control device;
setting up a secure connection between the first operating unit and the control device;
producing a first data connection between the first operating unit and the control device;
preventing a second data connection between a second operating unit and the control device by way of the control device.

The on-load tap-changer device located in the field is usually connected to a second operating unit, that is to say a server. The second data connection is used to transfer data, signals, etc. of the on-load tap-changer to the server by means of the second communication module of the control device. The server, that is to say the second operating unit, can process these data accordingly and derive actions therefrom, e.g. switching commands for the on-load tap-changer. These switching commands are then transferred to the control device via the second data connection, and the on-load tap-changer is actuated accordingly via the motor drive. A first communication unit of the control device monitors the close range of the on-load tap-changer device. As soon as a service employee with a first operating unit is now on site, that is to say in direct proximity to the on-load tap-changer device, this is detected by the first communication module. A manual or automatic attempt is made to produce a first data connection—mobile access—between the first operating unit and the control device.

The close range can be monitored by the first communication module of the control device in any manner, in particular constantly or at specific predetermined times. The first operating unit is detected automatically. Close range is understood to mean a radius of approx. 20 meters. The initial step for connection setup can be carried out by the control device or the service engineer by way of the first operating unit.

The second operating unit is designed and configured to process the data and signals received via the second data connection and to derive actions and switching commands for the on-load tap-changer device therefrom. This is possible because the second operating unit has access to the control device.

After the first connection has been produced, an attempt is made to set up a secure connection. A relationship of trust between the first operating unit and the control device is checked. The control device is appropriately designed and configured for this purpose or has appropriate means.

Furthermore, after the secure connection has been produced, the first operating unit is authorized and authenticated by the control device. The control device is appropriately designed and configured for this purpose or has appropriate means.

When the second data connection between the second operating unit and the control device is prevented, the commands and/or signals arriving from the second operating unit are either ignored and/or not processed further and/or cancelled by the control device. The important thing here is that only signals and commands from the first operating unit are then executed and transmitted by the control device. This protects the service engineer on site; secure mobile access is provided. This is accomplished after the first operating unit has been successfully connected to the control device, that is to say when the first operating unit has access to the control device.

The present disclosure and its advantages are described in more detail below with reference to the accompanying drawings ..

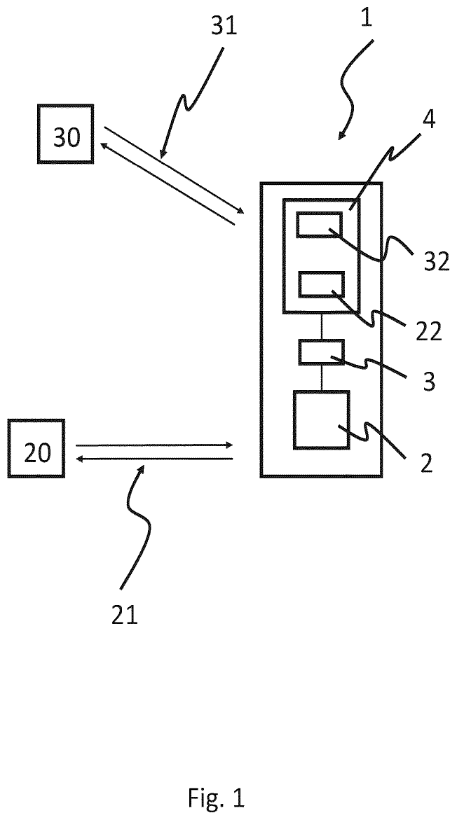

FIG. 1 shows a first embodiment of an on-load tap-changer device 1, a first operating unit 20 and a second operating unit 30. Both the first operating unit 20 and the second operating unit 30 are external operating units. The on-load tap-changer device 1 has an on-load tap-changer 2, a motor drive 3 and a control device 4. The on-load tap-changer device 1 is designed and configured, in particular by way of the control device 4, to produce a first data connection 21 between the on-load tap-changer device 1, that is to say the control device 4, and the first operating unit 20.

The first operating unit 20 is preferably in the form of a mobile terminal, that is to say a smartphone, notebook, etc. To produce the first data connection 21, the control device 4 comprises a first communication module 22, which is a short-range communication module and preferably produces a first data connection 21 to the first operating unit 20 via Bluetooth or WLAN. The first operating unit 20 is appropriately designed and configured to be able to enter into a first data connection 21 with the first communication module 22 and to grant the latter access. The first data connection 21 is a bidirectional connection that allows data to be sent and received by both the control device 4 and the first external operating unit 20.

The on-load tap-changer device 1 is designed and configured, in particular by way of the control device 4, to produce a second data connection 31 between the on-load tap-changer device 1, that is to say the control device 4, and the second external operating unit 30 and to grant the latter access.

The second operating unit 30 is preferably in the form of a server, computer, etc. To produce the second data connection 31, the control device 4 comprises a second communication module 32, which is a long-range communication module and preferably produces a second data connection 31 to the second operating unit 30 via LTE, MESH, 5G, LoRaWAN or any other mobile radio standard. The second operating unit 30 is appropriately designed and configured to be able to enter into a second data connection 31 with the second communication module 32. The second data connection is a bidirectional connection that allows data to be sent and received by both the control device 4 and the second external operating unit 30.

The control device 4 of the on-load tap-changer device 1 is designed and configured to control the motor drive 3 coupled to the on-load tap-changer 2 and thus to actuate the on-load tap-changer 2. The control device 4 has an appropriate processor and a memory for this purpose. The control device 4 can furthermore include a voltage controller that is used to decide when the on-load tap-changer 2 needs to be actuated.

Furthermore, the on-load tap-changer device 1 can comprise current sensors and voltage sensors connected to the control device 4. These sensors can firstly be connected to the voltage controller and secondly provide measurement data and signals, which are stored and processed in the control device and are transmitted to each of the operating units via the applicable data connection.

An existing second data connection 31 between the on-load tap-changer device 1 and the second operating unit 30 allows switching commands to be transmitted from the second operating unit 30 to the control device 4; the second operating unit has access to the control device 4. The control device 4 grants the second operating unit 30 access to the on-load tap-changer device 1 and thus to the on-load tap-changer 4. The measurement data determined by the current sensors and voltage sensors are transmitted to the second operating unit 30 and form a basis for possible switching commands. Thus, the on-load tap-changer device 1 is controlled by means of the second operating unit 30.

The measurement data can thus be stored and processed in the control device 4 itself or else in the second operating unit 30, so that the on-load tap-changer device 1 or the on-load tap-changer 2 can be controlled or actuated. In addition, the second data connection 31 can be used to transmit historical operating data determined by means of the control device 4 in the on-load tap-changer 2 to the second operating unit 30 and to evaluate them at a later time.

The transmitted data can preferably be switching commands on the on-load tap-changer, error messages of the on-load tap-changer, measurement data of the sensors, etc.

The first operating unit 20 is preferably in the form of a mobile device and provides the opportunity, above all for service engineers, to connect to the on-load tap-changer device 1; mobile access. The service engineers in this instance are on site, that is to say in direct proximity to the on-load tap-changer device 1. The first operating unit 20 then also has access to the on-load tap-changer device 1, and thus to the on-load tap-changer 4, as soon as the first data connection 21 exists. The service engineer can send different commands to the on-load tap-changer 4 or the on-load tap-changer device 1 via the control device 4, e.g. to trigger a manual switching operation. In addition, the service engineer can transmit historical operating data determined by means of the control device 4 in the on-load tap-changer 2 to their mobile terminal, that is to say the first operating unit 20, and perform evaluations immediately or at a later time.

For safety reasons, however, it is necessary for no other operating units, that is to say also no second operating unit 30, to be able to transfer switching commands to the on-load tap-changer 4 as soon as the first operating unit 20, that is to say a service engineer, is connected to the on-load tap-changer device 1. Therefore, the control device 4 is configured in such a way that the second data connection is prevented as soon as the first data connection 21 exists between the control device 4 and the first operating unit 20. For example, preventing can mean that the second data connection 31 is disconnected, for example by virtue of the second communication module 32 being switched off. In addition, preventing can mean that the incoming commands received via the second data connection are ignored, directly cancelled or simply not executed.

The control device 4 is furthermore designed and configured to detect connection setup and connection cleardown, and also connection interruptions for the first data connection 21 and the second data connection 31.

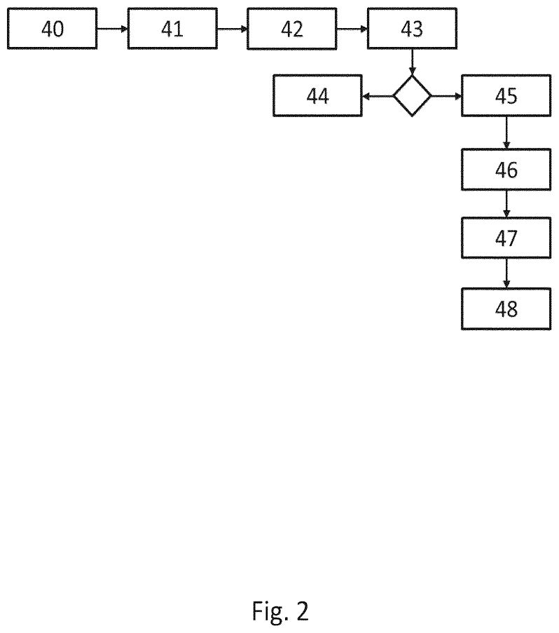

FIG. 2 shows a method sequence for mobile access to the on-load tap-changer device 1, in which a first operating unit 20 connects to the on-load tap-changer device 1, in particular to the control device 4 thereof.

The control device 4 of the on-load tap-changer device 1 monitors the close range (short-range communication channel) by means of the first communication module 22 of the control device 4 of the on-load tap-changer device and detects (step 40) when a first operating unit 20 uses this channel to attempt to produce a connection to the on-load tap-changer device 1.

After a first connection from the first operating unit 20 to the on-load tap-changer device 1 has been produced, a secure connection is set up in the next step 41. The TLS protocol can be used as an example of a secure connection here. In the first step here, an encrypted connection is produced between the first operating unit 20 and the on-load tap-changer device 1. AES encryption can be used as an example here, and the Diffie-Hellman method can be used as the key exchange algorithm.

In the next step 42, the relationship of trust between the first operating unit 20 and the on-load tap-changer device 1 is checked to rule out potential attacks such as man-in-the-middle attacks. The RSA method can be used as an example here.

In the next step 43, it must still be checked whether the user is actually permitted to log onto the on-load tap-changer device (authorization) and what rights this user has (authentication). This can be accomplished using a signed JWT token containing all the information needed for authorization and authentication. Checking the signature of the token ensures that the content of the token has not been altered and that it is a valid token. In addition, the other information in the token can be used to decide whether the user is granted access to the on-load tap-changer device 1.

If an error occurs during setup of the secure first data connection, the identity of the actors involved cannot be confirmed 100% or the authorization or authentication fails, the connection is terminated (step 44). In addition, if the connection is not set up successfully, all information sent during connection setup, such as certificates, basic values for calculating the session keys, etc., is erased. In step 45, authorization and authentication is performed.

After the first operating unit 20 has successfully connected to the on-load tap-changer device 1, that is to say a first data connection has been produced (step 46), the present state of the second data connection 31 is determined in step 47. In particular, the preference for whether or not data that arrive at the on-load tap-changer device 1 via the second data connection should be rejected is determined.

The present state of the second data connection 31 and in particular the preference for whether or not incoming data via the second data connection should be rejected are saved in a nonvolatile memory. A flash memory can be used as the nonvolatile memory here.

The preference that signals whether or not incoming data via the second data connection should be rejected is set such that the incoming data are rejected. Thus, the second data connection 31 between the second external operating unit 30 and the on-load tap-changer device 1 is prevented in step 48.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 on-load tap-changer device
2 on-load tap-changers
3 motor drive
4 control device
20 first operating unit
21 first data connection
22 first communication module
30 second operating unit
31 second data connection
32 second communication module

1. An on-load tap-changer device comprising:
a controller; and
an on-load tap-changer,
wherein the controller is designed and configured to produce a first data connection to a first operating unit,
wherein the controller is designed and configured to produce a second data connection to a second operating unit,
wherein the controller is designed and configured to use respective data connection of the first and second data connections to the first and second operating units to grant access to the controller and the on-load tap-changer, and
wherein the controller is designed and configured to prevent the second data connection between the second operating unit and the controller while the first data connection exists between the first operating unit and the controller.

2. The on-load tap-changer device as claimed in claim 1, wherein the first operating unit is an external operating unit.

3. The on-load tap-changer device as claimed in claim 1, wherein the second operating unit is an external operating unit.

4. The on-load tap-changer device as claimed in claim 1,
wherein the controller comprises a first communication module that is a short-range communication module, and
wherein the first operating unit is configured to use the first communication module to produce the first data connection to the controller.

5. The on-load tap-changer device as claimed in claim 1,
wherein the controller comprises a second communication module that is a long-range communication module, and
wherein the second operating unit is configured to use the second communication module to produce the second data connection to the controller.

6. A method for mobile access to an on-load tap-changer device, the method comprising:
monitoring a close range with a controller and detecting a first operating unit;
producing a first connection between the first operating unit and the controller;
setting up a secure connection between the first operating unit and the controller;
producing a first data connection between the first operating unit and the controller;
preventing a second data connection between a second operating unit and the controller by the controller.

7. The method as claimed in claim 6, wherein the close range is monitored by a first communication module of the controller, and wherein the first communication module detects the first operating unit.

8. The method as claimed in claim 6, comprising
checking, after the secure connection has been set up, a relationship of trust between the first operating unit and the controller.

9. The method as claimed in claim 6, comprising,
before a first data connection is produced, authorizing and authenticating the first operating unit is authorized and authenticated by the controller.

10. The method as claimed in claim 6, wherein
when the second data connection between a second operating unit and the controller is prevented, commands and/or signals arriving from the second operating unit are ignored and/or not processed further and/or cancelled by the controller.
